(19) United States
(12) Patent Application Publication
(10) Pub. No.: US 2022/0398622 A1
(43) Pub. Date: Dec. 15, 2022

(54) METHOD FOR BANKING INTEGRATION WITHIN A PRODUCT TREE BASED MULTI-LEVEL MARKETING SYSTEM

(71) Applicant: KwikClick, LLC, Murray, UT (US)

(72) Inventor: Fred Cooper, Farmington, UT (US)

(21) Appl. No.: 17/825,980

(22) Filed: May 26, 2022

Related U.S. Application Data
(60) Provisional application No. 63/193,268, filed on May 26, 2021.

(51) Int. Cl. G06Q 30/02; H04L 67/50

(52) U.S. Cl. CPC G06Q 30/0239; G06Q 30/0208; H04L 67/535

(57) ABSTRACT

Disclosed herein is a system and method to allow sellers of products to enroll a bank account in a multi-level marketing (MLM) system by providing the MLM system with a seller and a bank account to be issued and provides a first applicant to sign up for that bank account and then allow the purchaser to enroll themselves in the MLM system as well as to allow the bank account holder to easily advertise the bank account to a second applicant. *The second applicant can do the same, by applying for a bank account and, assuming they are approved, advertising to a third person and so on. *Commission is payed to the upline bank account holders based on transactions made by the persons they referred at preset commission levels. *Once the bank account holders are enrolled, they are provided with a code, to refer other users. *The bank account holding users can pass the code via link onto the user's followers, such as family, friends, colleagues, etc. to allow them to become part of the MLM tree. *The system also acts as a bank and allows users to open bank accounts which allows the system to collect data on user banking habits. Further, any bank account, whether issued by the MLM system or by another party, can be registered with the system just like any other product and commission can be paid upline whenever a user makes a bank account transaction. *Money stored by users within the MLM system can then be invested by the MLM, and users may be given a portion of the payoff of those investments in interest. Users may also be paid commission directly into their accounts for convenience.

### CROSS-REFERENCE TO RELATED APPLICATION

The present application claims the priority benefit of U.S. provisional application No. 63/193,268 filed May 26, 2021, the disclosure of which is incorporated herein by reference.

### FIELD OF THE DISCLOSURE

The present disclosure is generally related to multi-level marketing systems and commissions offered to users.

### BACKGROUND

A Multilevel marketing (MLM) system is a sales strategy used by some direct sales companies, which is used to encourage existing distributors to recruit new distributors who are paid a percentage of their recruits' sales. The recruits are the distributor's “downline.” Distributors also make money through direct sales of products to customers. Amway, which sells health, beauty, and home care products, is an example of a well-known direct sales company that uses multilevel marketing.

Multilevel marketing is a legitimate business sales strategy. One problem is that the MLM is organized as a pyramid tree. However, pyramid “schemes” that use money from new recruits to pay people at the top rather than those who perform the work is illegal. These pyramid schemes involve taking advantage of people by pretending to be engaged in legitimate multilevel or network marketing. You can spot pyramid schemes by their greater focus on recruitment than on product sales.

One issue in determining the legitimacy of a multilevel marketing company is whether it sells its products primarily to consumers or to its members who must recruit new members to buy their products. If it is the former, the company is likely a legitimate multilevel marketer. If it is the latter, it could be an illegal pyramid scheme.

Although each MLM company dictates its own specific financial compensation plan for the payout of any earnings to their respective participants, the common feature that is found across all MLMs is that the compensation plans theoretically pay out to participants only from two potential revenue streams. The first is paid out from commissions of sales made by the participants directly to their own retail customers. The second is paid out from commissions based upon the wholesale purchases made by other distributors below the participant who have recruited those other participants into the MLM; in the organizational hierarchy of MLMs, these participants are referred to as one's down line distributors.

MLM salespeople (distributors) are, therefore, expected to sell products directly to end-user retail consumers by means of relationship referrals and word of mouth marketing, but most importantly they are incentivized to recruit others to join the company's distribution chain as fellow salespeople so that these can become down line distributors.

*Banking is an effective way to gather capital while also providing a security and sometimes interest for a bank's clientele. Banks often offer referral bonuses to members who encourage others to start an account or deposit a specific amount of money into an account. Currently there is no MLM system that uses the bank account itself as a product on which upline users may receive commission. *Further, banks have access to a wealth of information about bank account user's money saving and spending habits which would be extremely useful for an MLM system to have, however, many of these companies keep this information proprietary or offer analytics services that make use of this data at a high price. *Currently, there is no MLM system that concurrently acts as a bank which allows users deposit and withdraw money, as well as earn interest on the money they have in their bank account. This bank account and other companies bank accounts can also be items within the MLM system with a portion of the interest, deposits, withdrawals, fees, and/or startup bonuses being payed upline. *This system allows the MLM system to integrate with existing bank account system, providing commission to members who convince others to sign up for and use bank accounts. It also allow the MLM system to itself become a bank and further simplify receiving commissions for users.

### DESCRIPTIONS OF THE DRAWINGS

FIG. 1: Illustrates a Multi-Level Marketing System.

FIG. 2: Illustrates an Admin Network Base Module.

FIG. 3: Illustrates an Admin Network Calculation Module.

FIG. 4: Illustrates an Admin Network Commission Module.

FIG. 5: Illustrates an Admin Network Advertising Module.

FIG. 6: Illustrates an Admin Network Admin Database.

FIG. 7: Illustrates an Admin Network Vendor Module.

FIG. 8: Illustrates an Admin Network Compensation Database.

FIG. 9: Illustrates an Admin Network Code Database.

FIG. 10: Illustrates an Admin Network From Bank Module.

FIG. 11: Illustrates an Admin Network Account Approval Module.

FIG. 12: Illustrates an Admin Network Banking Commission Module.

FIG. 13: Illustrates an Admin Network Withdrawal Module.

FIG. 14: Illustrates an Admin Network Interest Module.

FIG. 15: Illustrates an Admin Network Deposit Module.

FIG. 16: Illustrates an Admin Network User Account Module.

FIG. 17: Illustrates an Admin Network User Account Database.

FIG. 18: Illustrates an Admin Network Transaction Database.

FIG. 19: Illustrates an Admin Network Banking Commission Database.

FIG. 20: Illustrates a User Device Purchase Module.

FIG. 21: Illustrates a User Device User Database.

FIG. 22: Illustrates a User Device Downline Module.

FIG. 23: Illustrates a User Device Account Sign-up Module.

FIG. 24: Illustrates a User Device Banking Portal Module.

FIG. 25: Illustrates a 3rd Party Network 3rd Party Base Module.

FIG. 26: Illustrates a 3rd Party Network Admin Module.

FIG. 27: Illustrates a 3rd Party Network Discount Module.

FIG. 28: Illustrates a 3rd Party Network 3rd Party Database.

FIG. 29: Illustrates a Banking Institution To Admin Module.

FIG. 30: Illustrates a Banking Institution Accounting Database.

FIG. 31: Illustrates a Banking Institution Account Holder Database.

### DETAILED DESCRIPTION

FIG. 1 is a system for a Multi-Level Marketing System. This system comprises of *an Admin Network which includes an Admin Network Base Module 104, Admin Network Calculation Module 106, Admin Network Commission Module 108, Admin Network Advertising Module 110, Admin Network Admin Database 112, Admin Network Vendor Module 114, Admin Network Compensation Database 116, an Admin Network Code Database 118, an Admin Network From Bank Module 120, an Admin Network Account Approval Module 122, an Admin Network Banking Commission Module 124, an Admin Network Withdrawal Module 126, an Admin Network Interest Module 128, an Admin Network Deposit Module 130, an Admin Network User Account Module 132, an Admin Network User Account Database 134, an Admin Network Transaction Database 136, and an Admin Network Banking Commission Database 138. In some embodiments, a distributor may refer to the non-salaried workforce selling the company's products or services, while the earnings of the participants are derived from a pyramid-shaped or binary compensation commission system. In some embodiments, a product may refer to an article or substance that is manufactured or refined for sale. In some embodiments, a service may refer to a system supplying a public need such as transport, communications, or utilities such as electricity or water. A service may be an act of dealing with a customer in a store, restaurant, or hotel by taking their orders, showing, or selling them goods. Additionally, a service may be work that someone does or time that someone spends working for an organization, or a business that offers a particular type of help or work. In some embodiments, an MLM tree or commission tree may refer to the payment structure in which commissions are given out. In some embodiments, an MLM system may be referred to as network marketing which may be a business model that depends on person-to-person sales by independent representatives, often working from home. A network marketing business may require the independent representatives to build a network of business partners or salespeople to assist with lead generation and closing sales. In some embodiments, end of life of MLM tree may refer to the end of the MLM tree in which further participants in the MLM will not receive a commission, the commission tree starts up again, or the commission tree is restructured in some form. In some embodiments, an existing MLM system may refer to currently existing or established companies that use the sales strategies to encourage existing distributors to recruit new distributors who are paid a percentage of their recruits' sales. In some embodiments, the Admin Network may include data security as well as an MLM algorithm and may be able to connect to the app store. In some embodiments, data security may refer to the process of protecting data from unauthorized access and data corruption throughout its lifecycle. Data security may include data encryption, tokenization, and key management practices that protect data across all applications and platforms. In some embodiments, MLM algorithm may refer to the calculation performed using the compensation decay rate in order to calculate the commissions for downline participants. In some embodiments, connect app store refers to connecting the app store to an MLM system, at element 102. An Admin Network Base Module 104 which connects to the 3rd Party Network 3rd Party Base Module 160, initiates the Admin Network Vendor Module 114, and initiates the Admin Network Calculation Module 106. The 3rd Party Network 3rd Party Base Module 160 is the module that interacts with the sellers and the Admin Network Vendor Module 114 is the module that is loaded on the seller's computers system, at element 104. An Admin Network Calculation Module 106 which is initiated by the Admin Network Base Module 104, extracts the discount received from the 3rd Party Network 3rd Party Base Module 160 as well as the compensation plan or commission plan (e.g. its decay rate or commission structure so that each downline gets less and less commission) in order to determine the commissions for the MLM (Multi-Level Marketing) tree and stores the data in the Admin Network Compensation Database 116. In some embodiments, a commission may refer to a payment to someone who sells goods that is directly related to the amount sold, or a system that uses such payments. In some embodiments, a compensation plan or a commission plan may refers to the decay rate of the commissions provided to the MLM system from the discount offered by the 3rd Party, the 3rd Party also selects the decay rate in order to calculate the commissions offered to the first purchaser as well as the percentage offered to the downline participants, at element 106. An Admin Network Commission Module 108 which is continuously polling for the user data (the user being the product purchaser/distributor) from the 3rd Party Network Discount Module 164 and once it receives the data the Admin Network Commission Module 108 uses the data stored in the Admin Network Compensation Database 116 to determine the downline and upline commissions for the other users (product purchasers/distributors) within the MLM tree, and then initiates the Admin Network Advertising Module 110. In some embodiments, an upline may refer to the MLM distributors that recruits work for as salespeople to sell the products or services. In some embodiments, a downline may refer to the recruits the MLM distributors are able to secure as participants in the MLM system. In some embodiments, downline trees may go across country boundaries which may be the ability to pay out commissions for an MLM tree even though the participants in the MLM tree may not reside in the same country. In this case the commissions would need to be calculated for the appropriate exchange rate to ensure participants are paid in their residing countries currency in the correct amount, at element 108. An Admin Network Advertising Module 110, which is initiated by the Admin Network Commission Module 108, determines the user's (product purchasers/distributors) sphere of influence or contact list in order to provide the user's potential downline purchasers/distributors with a link and a code for the potential downline purchasers/distributors to become part of the MLM tree, at element 110. An Admin Network Admin Database 112, which is created through the Admin Network Vendor Module 114 (seller of a product), contains the data received from various 3rd Parties (various sellers) that are part of the MLM, the data may contain an item ID, description of the item, the original cost of the item, the discount for the item, the cost of the item with the discount, the compensation plan decay rate and a link to the item. In some embodiments, advertising link may refer to a link that directs a consumer to a product, service or good, at element 112. An Admin Network Vendor (those selling products) Module, which is initiated by the Admin Network Base Module 104, receives the data from the 3rd Party Network, stores the data in the Admin Network Admin Database 112, creates a link for the item and sends the link back to the 3rd Party Network and returns to the Admin Network Base Module 104, at element 114. An Admin Network Compensation Database 116, which is created through the Admin Network Calculation Module 106 and contains the various commissions for the different product purchasers/distributors, at element 116. An Admin Network Code Database 118 which contains the codes given to the product purchasers/distributors (users) for the product purchasers/distributors (user) to pass the code to their potential purchasers/distributors to advertise or promote the item that the user has purchased, at element 118. *An Admin Network From Bank Module 120 which receives data from the Banking Institution To Admin Module 172 on users who signed up for an out-of-network bank account using a code from the code database, which is stored in the Admin Network User Account Database 134, and transactions made by those users, from or to their out-of-network bank account, which are stored in the Admin Network Transaction Database 136, at element 120. *An Admin Network Account Approval Module 122 which receives data from the User Device Account Sign-up Module 152, that data is either approved or denied via an approval process which may be manual or automatic. If approved, bank account information is generated for the user and the generated data and the data received from the User Device Account Sign-up Module 152 is stored in the Admin Network User Account Database 134, at element 122. *An Admin Network Banking Commission Module 124 which polls for new data in the Admin Network Transaction Database 136, extracts the new data, checks the Admin Network Banking Commission Database 138 for the commission plan for that Banking Institution, calculates the commission to upline users, searches for the extracted user ID to find the upline users, then pays the calculated commission to the upline users, at element 124. *An Admin Network Withdrawal Module 126 which receives data on in-network bank account withdraws from the User Device Banking Portal Module 154, checks that the user has sufficient funds for the withdrawal, then stores the withdrawal data in the Admin Network Transaction Database 136 and sends money to the user, at element 126. *An Admin Network Interest Module 128 which polls the Admin Network Transaction Database 136 on a period schedule, calculates each user's account balance, calculates an interest payment on that balance based on an interest rate, and stores that interest payment in the Admin Network Transaction Database 136, at element 128. *An Admin Network Deposit Module 130 which receives deposit information from the User Device Banking Portal Modul, verifies the funds are valid, then stores the deposit in the Admin Network Transaction Database 136, at element 130. *An Admin Network User Account Module 132 which receives requests for user's account balance information from the User Device Banking Portal Module 154, extracts the user's transaction data from the Admin Network Transaction Database 136, then sends the data back to the User Device Banking Portal Module 154, at element 130. *An Admin Network User Account Database 134 which stores information about users who have a bank account including user ID, address, bank account number, bank account routing number, account type, code used to sign up, Banking Institution, and any other identifying information which may be used as part of a bank account application process or is usually collected by Banking Institutions, at element 132. *An Admin Network Transaction Database 136 which stores transactions made by users with bank accounts, transactions may include a user ID, bank account number, time and data, type of transaction, transaction amount, whether the transaction is pending, whether the transaction was made using an in-network or out-of-network bank account, or any other metric which is usually collected by Banking Institutions when account holders make a deposit or withdrawal, or are paid interest, at element 134. *An Admin Network Banking Commission Database 138 which stores commission plans for each individual Banking Institution, the plans may treat each type of transaction differently, for example, deposits may have a different commission structure than withdrawals, in some embodiments commission plans may be separated by account type (Savings, Checking, Money Market, etc.), user ID, sign-up date, etc. at element 136. The Cloud or communication network may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over Internet and relies on sharing of resources to achieve coherence and economies of scale, like a public utility, while third-party clouds enable organizations to focus on their core businesses instead of expending resources on computer infrastructure and maintenance, at element 138. A User (product purchasers/distributors) Device such as a laptop, smartphone, table, computer, or smart speaker, at element 140. The User Device Comms or communication network may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over Internet and relies on sharing of resources to achieve coherence and economies of scale, like a public utility, while third-party clouds enable organizations to focus on their core businesses instead of expending resources on computer infrastructure and maintenance, at element 142. A User Device Purchase Module 146 which connects to the 3rd Party Network, allows a purchaser/distributor to select an item and the associated link, determines if the purchaser/distributor entered a code, and sends the link and code, if available, to the 3rd Party Network, at element 144. A User Device User Database 148 which contains the user's (product purchasers/distributors) followers (sphere of influence) as well as the followers contact information in order for them to receive commissions on their purchases. In some embodiments, a distributor contact list or followers may refer to the recruits or followers on social media that a distributor has secured to participant in their downline. In some embodiments, the User Device User Database 148 may include ratings and recommendations from the users. In some embodiments, rating and recommendation modules may refer to modules in which a company, entity, or person provides ratings and/or recommendations for products, goods, or services, at element 146. A User Device Downline Module 150 which is continuously polling to receive the code and link from the Admin Network Advertising Module 110 to allow the purchaser/distributor to pass the code and link to the user's followers stored in the User Device User Database 148, at element 148. *A User Device Account Sign-up Module 152 which allows a user to enter data into an application to be approved for an in-network bank account, this data is sent to the Admin Network Account Approval Module 122, in an embodiment the User Device Account Sign-up Module 152 may also be used to apply for out-of-network bank accounts, at element 150. *A User Device Banking Portal Module 154 allows a user to view their in-network bank account statement and make deposits and withdrawals, in embodiments where a user can have multiple bank accounts the User Device Banking Portal Module 154 may also allow for transfers between accounts, at element 152. A 3rd Party Network which is the various 3rd Parties, such as retail stores including stores that sell product consumables, services, franchises, service networks, large box stores, or e-commerce sites that allow e-commerce sales and may include an e-commerce shopping cart, that offer items to users at a discount, such as a product discount, in order to use MLM. In some embodiments, a franchise may refer to an authorization granted by a government or company to an individual or group enabling them to carry out specified commercial activities, e.g. providing a broadcasting service, or acting as an agent for a company's products. In some embodiments, product consumables may refer to goods by individuals and businesses that must be replaced regularly because they wear out or are used up. In some embodiments, service networks refer to a collection of people and information brought together on the internet to provide a specific service or achieve a common business objective, such as Angie's List. In some embodiments, e-commerce sale may refer to sales of goods and services where the business takes place over the internet, an extra-net, Electronic Data Interchange (EDI), or other online system. Payment may or may not be made online. Business in this context is defined as an order placed by the buyer or price and terms of sale negotiated. In some embodiments, e-commerce shopping cart may refer to a software used in E-commerce to assist visitors to make purchases online. Upon checkout, the software calculates the total of the order, including shipping and handling, taxes, and other parameters the owner of the site has previously set. In some embodiments, retailer may refer to a person or business that sells goods to the public in relatively small quantities for use or consumption rather than for resale. In some embodiments, product discounts may refer to a reduce price or something being sold at a price lower than that item is normally sold for. It is a reduction to a basic price for a good or service. In some embodiments, large box stores may refer to a physically large retail establishment, usually part of a chain of stores, offers a variety of products to its customers. The term sometimes refers, by extension, to the company that operates the store, and may be referenced as a supercenter, superstore, megastore, etc. These stores achieve economies of scale by focusing on large sales volumes. Because volume is high, the profit margin for each product can be lowered, which results in very competitively priced goods. The term “big-box” is derived from the store's physical appearance, at element 154. The 3rd Party Network Comms or communication network may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over Internet and relies on sharing of resources to achieve coherence and economies of scale, like a public utility, while third-party clouds enable organizations to focus on their core businesses instead of expending resources on computer infrastructure and maintenance, at element 156. A 3rd Party Network 3rd Party Base Module 160 which initiates the 3rd Party Network Admin Module 162, continuously polls for the user to select a link, receives the purchaser/distributor data, and initiates the 3rd Party Network Discount Module 164, at element 158. A 3rd Party Network Admin Module 162 which is initiated from the 3rd Party Network Base Module, connects to the Admin Network, sends the data for the items to be purchased, receives a link from the Admin Network, stores the link in the 3rd Party Network Database and returns to the 3rd Party Network 3rd Party Base Module 160, at element 160. A 3rd Party Network Discount Module 164 which is initiated from the 3rd Party Network 3rd Party Base Module 160, extracts the link and compares it to the 3rd Party Network 3rd Party Database 166 to extract the corresponding discount for the selected item, the discount is applied to the user order and it is determined if the user entered a code or not, the order is processed and the process returns to the 3rd Party Network 3rd Party Base Module 160, at element 162. A 3rd Party Network 3rd Party Database 166 which contains information about the item the 3rd Party selects to offer at a discount for the Admin Network. In some embodiments, the 3rd Party Network 3rd Party Database 166 may include local media for the product or service. In some embodiments, local media may refer to the various types of media, such as photos, videos, text, sounds, haptics, online product descriptions, etc. for enhanced marketing, at element 164. *A Banking Institution which may be a bank, or any other institution which may issue a bank account and collects data on that bank account's holder and the transactions made with that bank account. bank accounts provided by these companies are considered to be out-of-network bank accounts since the Admin Network does not control the bank account approval process or handle the transactions made via the bank account. In some embodiments a Banking Institution may also offer products and services that are not related to bank accounts or banking. In some embodiments a Banking Institution may also be a 3rd Party. In some embodiments the Admin Network and a Banking Institution may be the same entity in which case bank accounts issued by the co-owned Banking Institution may be considered in-network bank accounts, in an embodiment where the Banking Institution is also a bank a user who is referred for banking services and uses a code from the code database may automatically have that code applied when they apply for a bank account from that bank, at element 166. *A Banking Institution Comms or communication network may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over Internet and relies on sharing of resources to achieve coherence and economies of scale, like a public utility, while third-party clouds enable organizations to focus on their core businesses instead of expending resources on computer infrastructure and maintenance, at element 168. *A Banking Institution To Admin Module 172 which polls for new data in the Banking Institution Accounting Database 174 or Banking Institution Account Holder Database 176 and sends that data to the Admin Network Transaction Database 136 or Admin Network User Account Database 134 respectively, at element 170. *A Banking Institution Accounting Database 174 which contains transactions made by users who obtained a bank account from the Banking Institution using a referral code from the Admin Network Code Database 118, at element 172. *A Banking Institution which contains the bank account information and personal information of users who obtained a bank account from the Banking Institution using a referral code from the Admin Network Code Database 118, at element 174.

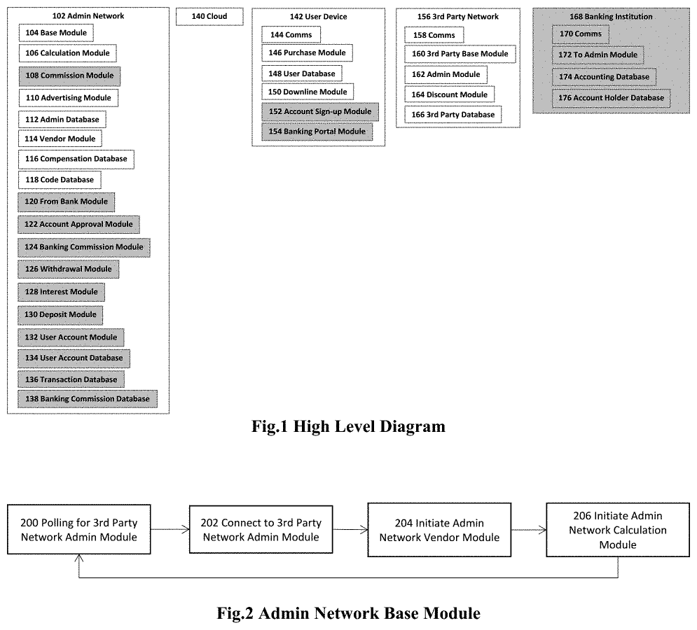

Functioning of the Admin Network Base Module 104 will now be explained with reference to FIG. 2. The process begins with the Admin Network Base Module 104 continuously polls for the 3rd Party Network Admin Module 162 (sellers of products), at step 200. The Admin Network Base Module 104 connects to the 3rd Party Network Admin Module 162 (sellers of products), at step 202. Once the Admin Network Base Module 104 connects to the 3rd Party Network Admin Module 162 the Admin Network Base Module 104 initiates the Admin Network Vendor Module 114, at step 204. Then the Admin Network Base Module 104 initiates the Admin Network Calculation Module 106 and the process returns to step 200, at step 206.

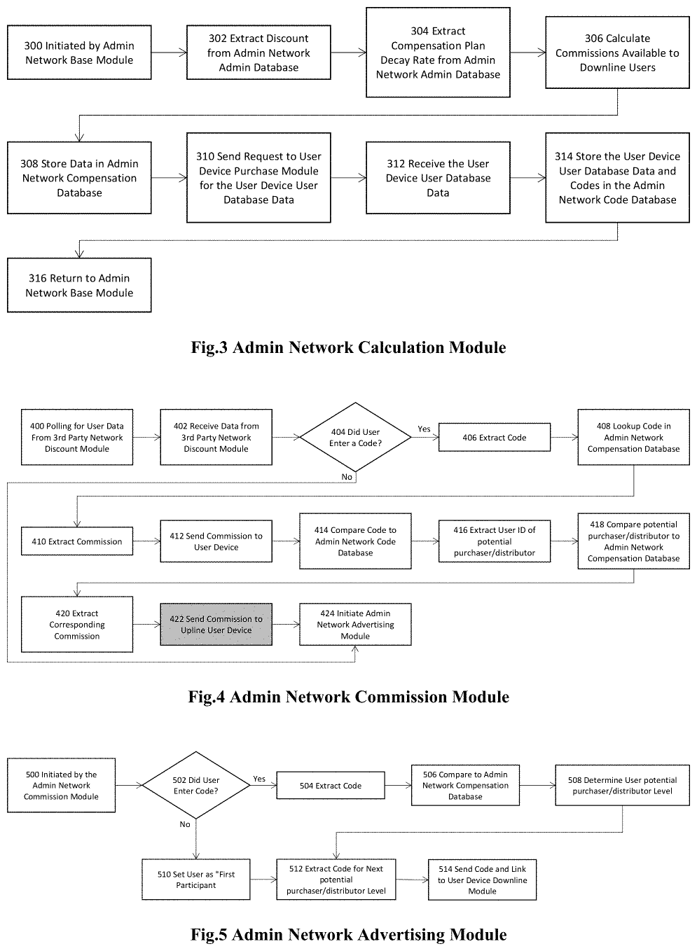

Functioning of the Admin Network Calculation Module 106 will now be explained with reference to FIG. 3. The process begins with the Admin Network Base Module 104 initiating the Admin Network Calculation Module 106, at step 300. The Admin Network Calculation Module 106 extracts the discount from the Admin Network Admin Database 112, which is received from the 3rd Party Network, at step 302. Then the Admin Network Calculation Module 106 extracts the compensation plan decay rate from the Admin Network Admin Database 112, at step 304. The Admin Network Calculation Module 106 determines the commissions available to the downline users, or the followers of the user that purchased the item. In some embodiments, the commissions may be calculated by using the discount on the item and providing 50% of the discount to the first participant and then the remaining amount of the discount for the downline users at a 50% decay rate. For example, if the first user purchased an item that was originally $59.00 discounted by 15%, the first user to make the purchase would receive $3.32 or 50% of the discount. Then any follower of the user who made the initial purchase would receive 50% of the remaining discount or 50% of $3.32, and this may continue until there is only one cent left to pay out as a commission for the downline users, at step 306. Then the Admin Network Calculation Module 106 stores the data in the Admin Network Compensation Database 116, at step 308. The Admin Network Calculation Module 106 sends a request to the User Device Purchase Module 146 for the data stored in the User Device User Database 148, at step 310. Then the Admin Network Calculation Module 106 receives the User Device User Database 148 data from the User Device Purchase Module 146, at step 312. The Admin Network Calculation Module 106 stores the received data, as well as the code data, in the Admin Network Code Database 118, at step 314. The Admin Network Calculation Module 106 then returns to the Admin Network Base Module 104, at step 316.

Functioning of the Admin Network Commission Module 108 will now be explained with reference to FIG. 4. The process begins with the Admin Network Commission Module 108 continuously polling for the user data from the 3rd Party Network Discount Module 164, at step 400. The Admin Network Commission Module 108 receives the user data from the 3rd Party Network Discount Module 164, at step 402. Then the Admin Network Commission Module 108 determines if the user entered a code, at step 404. If the user did enter a code the Admin Network Commission Module 108 extracts the code the user entered, at step 406. The extracted code is then looked up in the Admin Network Compensation Database 116 which contains the various commissions for the different sphere of influence or potential product purchasers/distributors levels as well as the associated code for each of the different sphere of influence levels, at step 408. Then the Admin Network Commission Module 108 extracts the corresponding commission for the code that was looked up in the Admin Network Compensation Database 116, at step 410. The Admin Network Commission Module 108 sends the commission to the user (purchaser/distributor). In some embodiments, the Admin Network Commission Module 108 may track profits and payments as well as track taxes for users enrolled in the MLM system. In some embodiments, track profits and payments may refer to the MLM system tracking the profits of the MLM and tracking the payments or commissions paid out to participants. In some embodiments, track taxes may refer to tracking the commissions provided to participants for tax purposes, at step 412. Then the Admin Network Commission Module 108 compares the extracted code to the Admin Network Code Database 118 which contains the list of users and the code sent to the user's followers, at step 414. The Admin Network Commission Module 108 extracts the user ID and sphere of influence or potential purchaser/distributor by using the extracted code, at step 416. Then the Admin Network Commission Module 108 compares the extracted sphere of influence or potential purchaser/distributor to the Admin Network Compensation Database 116, at step 418. The Admin Network Commission Module 108 uses the extracted sphere of influence to extract the corresponding commission from the Admin Network Compensation Database 116, at step 420. *The Admin Network Commission Module 108 sends the commission to the upline user, in an embodiment this commission may be directly deposited into the user's bank account and the transaction data would be stored in the Admin Network Transaction Database 136, at step 422. If the user did not enter a code, the Admin Network Commission Module 108 initiates the Admin Network Advertising Module 110, at step 424.

Functioning of the Admin Network Advertising Module 110 will now be explained with reference to FIG. 5. The process begins with the Admin Network Commission Module 108 initiating the Admin Network Advertising Module 110, at step 500. The Admin Network Advertising Module 110 determines if the user entered a code, at step 502. If it is determined that the user entered a code the code is extracted, at step 504. The Admin Network Advertising Module 110 compares the extracted code to the Admin Network Compensation Database 116, at step 506. The Admin Network Advertising Module 110 determines the user's sphere of influence level, at step 508. If it is determined that the user did not enter a code then the Admin Network Advertising Module 110 sets the user as the “First Participant”, at step 510. Then the Admin Network Advertising Module 110 extracts the code for the next sphere of influence level or potential purchaser/distributor in order to provide the user's followers with a code that would allow them to join the Multi-Level Marketing tree, at step 512. The Admin Network Advertising Module 110 sends code and the link to the item to the User Device Downline Module 150, at step 514.

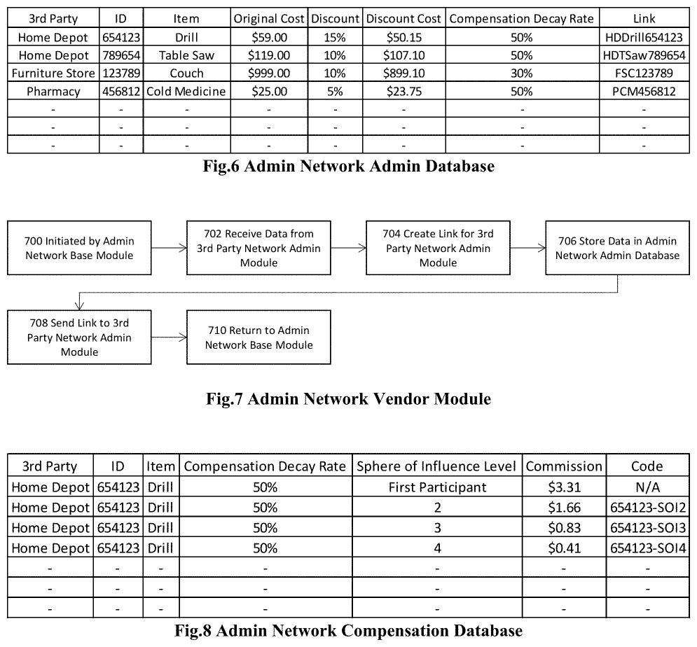

Functioning of the Admin Network Admin Database 112 will now be explained with reference to FIG. 6. This figure displays the Admin Network Admin Database 112 which is created through the Admin Network Vendor Module 114. The Admin Network Vendor Module 114 receives the item data from the 3rd Party Network, creates a link for the item, stores the data in the Admin Network Admin Database 112 and sends the created link back to the 3rd Party Network. The Admin Network Admin Database 112 contains the data collected from various 3rd Parties that enrolled in the Multi-Level Marketing System. The Admin Network Admin Database 112 contains the name of the 3rd Party, the ID for the item, an description of the item, the original cost of the item, the discount provided by the 3rd Party, the cost of the item with the discount, the compensation decay rate or how the downline commissions are calculated, and the link to the item. In some embodiments, the Admin Network Admin Database 112 may include communicating events with the downlines and uplines, dynamic incentives and rewards for a product, marketing materials, banking referrals, materials for suggestive selling, etc. In some embodiments, communicate events with downlines and uplines refer to advertising events to participants in an MLM system. In some embodiments, dynamic incentives and rewards for a product may refer to incentives or rewards that are continuously updated for a product. In some embodiments, marketing materials may refer to a means of marketing, advertising or promotional materials developed by or for license (or subject to licensee's approval) that promote the sale of the licensed product, including but not limited to, television, radio and online advertising, point of sale materials (e.g. posters, counter-cards), packaging advertising, print media and all audio or video media. In some embodiments, banking referral may refer to a structured flow of collecting and organizing referrals for banks. Businesses who have been unsuccessful in a credit application process with a bank will be asked for their permission to have their financial information passed to designated finance platforms who can contact the business in a regulated time-frame. In some embodiments, suggestive selling may refer to a sales technique where an employee asks a customer if they would like to include an additional purchase or recommends a product which might suit the client.

Functioning of the Admin Network Vendor Module 114 will now be explained with reference to FIG. 7. The process begins with the Admin Network Base Module 104 initiating the Admin Network Vendor Module 114, at step 700. The Admin Network Vendor Module 114 receives the data from the 3rd Party Network Admin Module 162 which may include the item to be enrolled in the MLM system, the original cost of the item, the discount provided by the 3rd Party, the cost of the item with the discount, the compensation plan decay rate, etc., at step 702. Then the Admin Network Vendor Module 114 creates a link for the item for the 3rd Party Network Admin Module 162. A vendor is a seller of a product, such as a retailer, at step 704. The Admin Network Vendor Module 114 stores the received data and the created link in the Admin Network Admin Database 112, at step 706. The Admin Network Vendor Module 114 sends the link to the 3rd Party Network Admin Module 162, at step 708. The Admin Network Vendor Module 114 returns to the Admin Network Base Module 104, at step 710.

Functioning of the Admin Network Compensation Database 116 will now be explained with reference to FIG. 8. This figure displays the Admin Network Compensation Database 116 which is created through the Admin Network Calculation Module 106. The Admin Network Calculation Module 106 extracts the discount and the compensation plan decay rate in order to calculate the downline commissions for additional users and the various sphere of influence levels are stored in the Admin Network Compensation Database 116. The Admin Network Compensation Database 116 contains the 3rd Party, the ID for the item, the item, the compensation plan decay rate, the various sphere of influence levels, the commission for each sphere of influence level and the code to be used by the user's followers to enroll in the MLM system. In some embodiments, the Admin Network Compensation Database 116 may include a lottery structure for how the commissions are paid to users or freelancers. In some embodiments, lottery may refer to a process or thing whose success or outcome is governed by chance. A means of raising money by selling number tickets and giving prizes to the holders of number drawn at random. In some embodiments, freelancers may refer to a person who works as a writer, designer, performer, or the like, selling work or services by the hour, day, job, etc., rather than working on a regular salary basis for one employer.

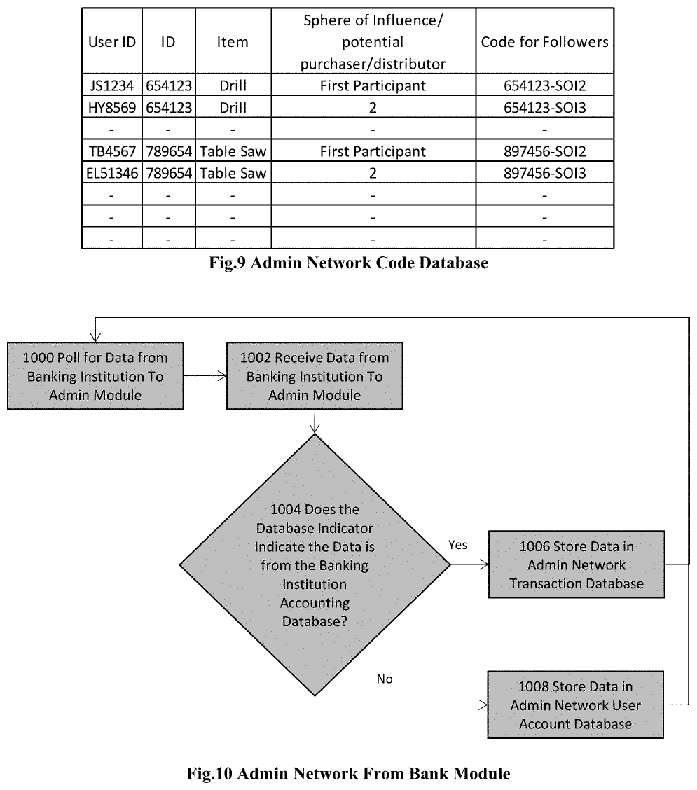

Functioning of the Admin Network Code Database 118 will now be explained with reference to FIG. 9. The Admin Network Code Database 118 which is used to determine the sphere of influence of the purchaser/distributor from the code that was used when a purchaser/distributor purchased a product or item from a 3rd Party. The Admin Network Code Database 118 contains User ID, ID, Item, Sphere of Influence/potential purchaser/distributor, and Code for Followers.

Functioning of the Admin Network From Bank Module 120 will now be explained with reference to FIG. 10. *The process begins with the Admin Network From Bank Module 120 polling for data from the Banking Institution To Admin Module 172, which contains at least an indicator of which database the data originated from, for example “1” for the Banking Institution Accounting Database 174 and “0” for the Banking Institution Account Holder Database 176, at step 1000. *The Admin Network From Bank Module 120 receives the data from the Banking Institution To Admin Module 172, for example, entries from the Banking Institution Accounting Database 174, at step 1002. *The Admin Network From Bank Module 120 determines if the database indicator sent with the data indicates that the data originated in the Banking Institution Accounting Database 174, for example, the indicator may be “1” for the Banking Institution Accounting Database 174 and “0” for the Banking Institution Account Holder Database 176, the Admin Network From Bank Module 120 would then interpret “1” as the statement TRUE in binary and determine that the database indicator is indicating that it is true that the data originated in the Banking Institution Accounting Database 174, as such the database indicator is a Boolean variable with a value of 1 or 0, or TRUE or FALSE, which the Admin Network From Bank Module 120 uses as the argument of an IF statement in the computer code, if the IF statement returns a value of TRUE then the Admin Network From Bank Module 120 executes step 1006, if the IF statement returns a value of FALSE then the Admin Network From Bank Module 120 will execute step 1008, in some embodiments the Banking Institution may have more than two databases and the Admin Network From Bank Module 120 may include additional steps to determine which database on the Admin Network the data will ultimately be stored in, in which case the computer code will need to user either nested IF statements or a SWITCH statement, at step 1004. *If the database indicator sent with the data indicates that the data originated in the Banking Institution Accounting Database 174, the Admin Network From Bank Module 120 stores the data in the Admin Network Transaction Database 136, this data is data on user transactions which include deposits, withdrawals, and interest, at step 1006. *If the database indicator sent with the data indicates that the data originated in the Banking Institution Account Holder Database 176, the Admin Network From Bank Module 120 stores the data in the Admin Network User Account Database 134, this data is user data which contains a user's personal information so that the bank account can be tied to the user, at step 1008.

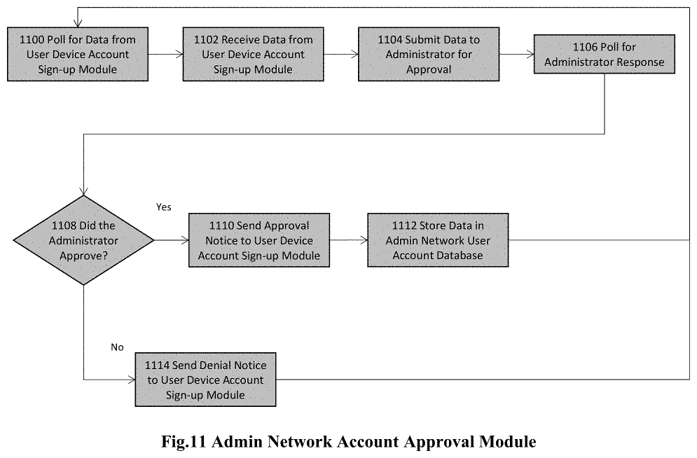

Functioning of the Admin Network Account Approval Module 122 will now be explained with reference to FIG. 11. *The process begins with *the Admin Network Account Approval Module 122 polling for data from the User Device Account Sign-up Module 152, for example, the user's user ID, billing address, full name, social security number, and other information which is usually required to apply for a bank account, at step 1100. *The Admin Network Account Approval Module 122 receives data from the User Device Account Sign-up Module 152, for example, the user's user ID, billing address, full name, social security number, and other information which is usually required to apply for a bank account, at step 1102. *The Admin Network Account Approval Module 122 sends the data to an administrator to be approved, an administrator may be, for example, an owner of the Admin Network, a person hired to handle bank account approval, or an independent entity that handles bank account approval, in an embodiment the data is sent to another module which approves or denies an application for a bank account automatically, the data may be displayed on a GUI as part of the Admin Network or may be sent to an administrator via email, text, fax, etc., at step 1104. *The Admin Network Account Approval Module 122 polls for a response from the administrator, in an embodiment more than one administrator response may be required before the module continues, at step 1106. *The Admin Network Account Approval Module 122 determines if the administrator approved the bank account application, for example, the administrator may manually change a variable called “approved” from false to true, at step 1108. *If the administrator approved the bank account application, the Admin Network Account Approval Module 122 sends a notice of approval to the User Device Account Sign-up Module 152, for example, “You've been approved!” or “Sign-up Successful.”, at step 1110. *The Admin Network Account Approval Module 122 stores the bank account application data in the Admin Network User Account Database 134, for example, the user's user ID, billing address, full name, social security number, and other information which is usually required to apply for a bank account, at step 1112. *If the administrator denied the bank account application, the Admin Network Account Approval Module 122 sends a notice of denial to the User Device Account Sign-up Module 152, for example, “You've been denied.” or “Application error, please try again.”, at step 1114.

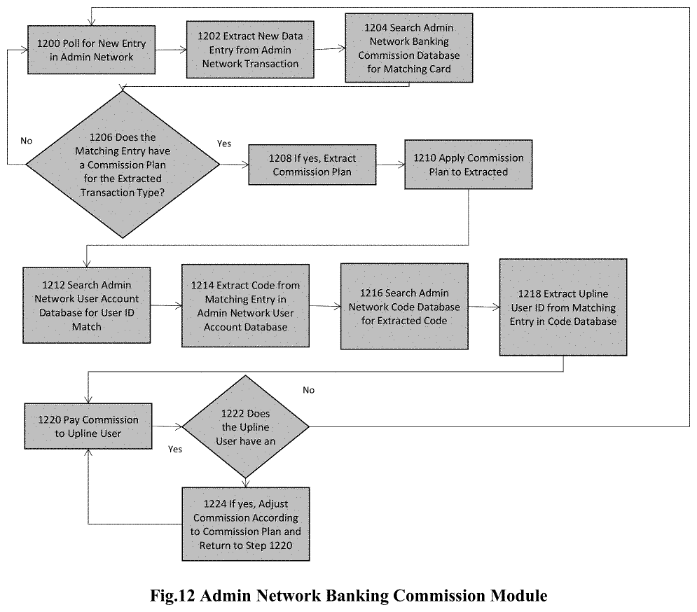

Functioning of the Admin Network Banking Commission Module 124 will now be explained with reference to FIG. 12. *The process begins with *the Admin Network Banking Commission Module 124 polling for a new entry in the Admin Network Transaction Database 136, the entry includes, a user ID, for example, JS1234, bank account number, for example, 543093105088, time and date, for example, 6/19/2020 11:30:00 AM, type of transaction, for example an interest payment, transaction amount, for example, $3.21, whether the transaction is pending, whether the transaction was made using an in-network or out-of-network bank account, or any other metric which is usually collected by bank account companies in regards to bank account deposits, withdrawals, or interest payments, at step 1200. *The Admin Network Banking Commission Module 124 extracts all the data in the new entry in the Admin Network Transaction Database 136, the entry includes, a user ID, for example, JS1234, bank account number, for example, 543093105088, time and date, for example, 6/19/2020 11:30:00 AM, type of transaction, for example an interest payment, transaction amount, for example, $3.21, whether the transaction is pending, whether the transaction was made using an in-network or out-of-network bank account, or any other metric which is usually collected by bank account companies in regards to bank account deposits, withdrawals, or interest payments, at step 1202. *The Admin Network Banking Commission Module 124 searches the Admin Network Banking Commission Database 138 for an entry that matches the Banking Institution from the extracted data, at step 1204. *The Admin Network Banking Commission Module 124 determines if the matching entry has a commission plan for the type of transaction extracted, for example, if the extracted transaction type is “Deposit” then the Admin Network Banking Commission Module 124 which check if the matching entry contains a commission plan for deposits under the deposit commission plan category, if no plan is found then the Banking Institution does not offer commission on this type of transaction and the Admin Network Banking Commission Module 124 returns to polling for another new entry in the Admin Network Transaction Database 136, at step 1206. *If the matching entry has a commission plan for the type of transaction extracted, the Admin Network Banking Commission Module 124 extracts that commission plan from the Admin Network Banking Commission Database 138, for example, the file Depositplan.dat may contain the following code:

If (deposit_Amount <= 50)
commission = deposit Amount * 0.02f
else if (deposit_Amount > 50 && deposit_Amount <= 1000)
commission = (deposit_Amount - 50) * 0.01f + 1
else
commission = deposit_Amount * (0.01f / log(deposit_Amount)) + 11

deposit_Amount being the value of the extracted data from the amount category, a commission plan data file may hold a simple equation that pays upline users at a decaying rate, or may be much more complex involving different commission structures based on the type of product deposited, for example, gas may pay 3% upline at a 50% decay rate where as food deposits may pay 1% upline at a 40% decay rate, at step 1208. *The Admin Network Banking Commission Module 124 applies the commission plan to the extracted transaction amount, for example, if the commission plan is 2% of the amount with a decay rate of 50% then the first commission to the direct upline user would be 2% of the transaction amount, the user upline of that user would receive 2% multiplied by 50% or 1% of the transaction amount, etc., in some embodiments the commission plan may be a simple equation which the Admin Network Banking Commission Module 124 enters the transaction amount into to get the commission, in other embodiments the commission plan may be so complex as to require a set of instructions which the Admin Network Banking Commission Module 124, any maybe other modules, are able to execute, at step 1210. *The Admin Network Banking Commission Module 124 searches the Admin Network User Account Database 134 for a user ID in the user ID category that matches the user ID in the extracted transaction data, at step 1212. *The Admin Network Banking Commission Module 124 extracts the code from the entry that matches the extracted user ID from the Admin Network User Account Database 134, at step 1214. *The Admin Network Banking Commission Module 124 searches the Admin Network Code Database 118 for the extracted code, at step 1216. *The Admin Network Banking Commission Module 124 extracts the upline user's user ID from the entry that matches the code extracted from the Admin Network User Account Database 134, at step 1218. *The Admin Network Banking Commission Module 124 pays the commission, in an embodiment this payment may be made as a deposit directly into the user's account and stored as a transaction in the Admin Network Transaction Database 136, at step 1220. *The Admin Network Banking Commission Module 124 determines if the upline user also has an upline user by determining if the sphere of influence in the Admin Network Code Database 118 for that user is “first participant” or not, if the user has no upline users then the Admin Network Banking Commission Module 124 returns to polling for a new entry in the Admin Network Transaction Database 136, at step 1222. *If the upline user also has an upline user, the Admin Network Banking Commission Module 124 adjusts the commission according to the commission plan and returns to step 1220, for example, if the commission plan is a decay rate plan then the commission would be reduced by the decay rate, at step 1224.

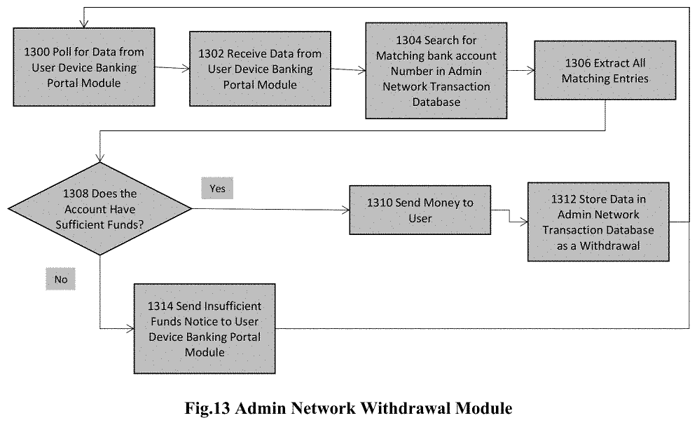

Functioning of the Admin Network Withdrawal Module 126 will now be explained with reference to FIG. 13. *The process begins with the Admin Network Withdrawal Module 126 polling for data from the User Device Banking Portal Module 154, which includes at least a bank account number and withdrawal amount but may also include account type, routing number, billing information, etc., at step 1300. *The Admin Network Withdrawal Module 126 receives data from the User Device Banking Portal Module 154, which includes at least a bank account number and withdrawal amount but may also include account type, routing number, billing information, etc., at step 1302. *The Admin Network Withdrawal Module 126 searches the Admin Network Transaction Database 136 for a bank account Number that matches the bank account Number in the bank account category in the data from the User Device Banking Portal Module 154, in some embodiments routing number, account type, user address, some other data parameter, or any combination of these parameters may also need to match, at step 1304. *The Admin Network Withdrawal Module 126 extracts all matching entries from the Admin Network Transaction Database 136, entries may include a user ID, for example, JS1234, bank account number, for example, 543093105088, time and date, for example, 6/19/2020 11:30:00 AM, type of transaction, for example an interest payment, transaction amount, for example, $3.21, whether the transaction is pending, whether the transaction was made using an in-network or out-of-network bank account, or any other metric which is usually collected by bank account companies in regards to bank account deposits, withdrawals, or interest payments, at step 1306. *The Admin Network Withdrawal Module 126 determines if the user has sufficient funds to make this withdrawal by calculating the user's account balance and determining if the withdrawal is higher or lower, if lower the user has sufficient funds in their account, in an embodiment the account balance is determined by adding together all the amounts of the user's deposits and interest fees, minus all the withdrawals the user has made, in some embodiments the calculation may be done by subtracting deposits and interest from withdrawals, adding deposits and interest to withdrawals as negative numbers, etc., in an embodiment, pending transactions are not included, in an embodiment the bank account may be tied to a credit card system in which case the user may make a withdrawal greater than their available balance, the remainder of which is borrowed against their line of credit or the user may overdraft the account and be charged a fee or interest on the debt, at step 1308. *If the user has sufficient funds to make this withdrawal, the Admin Network Withdrawal Module 126 sends money equal to the withdrawal amount to the user, in some embodiments this may be done via cash at an atm, check, money order, debit, PayPal, Zelle, or any other money transfer system, at step 1310. *The Admin Network Withdrawal Module 126 stores the data received from the User Device Banking Portal Module 154 in the Admin Network Transaction Database 136 as a withdrawal, in an embodiment, if the user ID was not received from the User Device Banking Portal Module 154 then it can be obtained by extracting it from the matching entry in the Admin Network User Account Database 134, at step 1312. *If the user does not have sufficient funds to make this withdrawal, the Admin Network Withdrawal Module 126 sends an insufficient funds notice to the User Device, in an embodiment a verification notice is a simple Boolean true or false statement which is used by a module to display a written notice, in other embodiments a message may be sent via SMS text, email, or pop-up window, for example, “Insufficient Funds for Withdrawal.”, at step 1314.

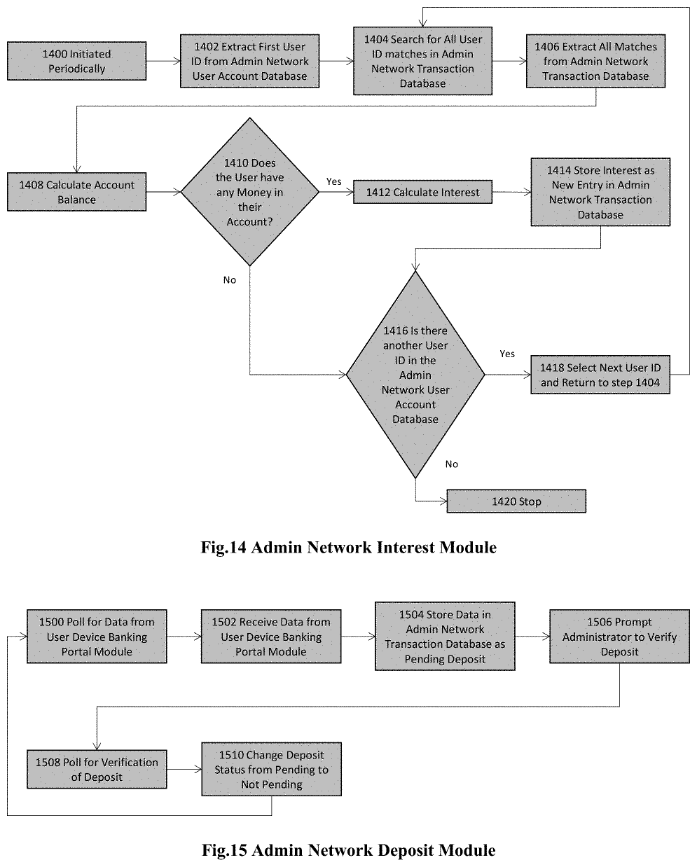

Functioning of the Admin Network Interest Module 128 will now be explained with reference to FIG. 14. *The process begins with the Admin Network Interest Module 128 being initiated periodically at 11:59 PM every day, in some embodiments this initiation may be done by another module, in another embodiment the Admin Network Interest Module 128 may poll a database or an internal clock for a time interval, the period chosen is based on when interest should be calculated, for example, hourly, weekly, monthly, etc., at step 1400. *The Admin Network Interest Module 128 extracts the first user ID in the Admin Network User Account Database 134, in embodiments where the Admin Network Interest Module 128 is run on a different time schedule for individual users the user ID of the user that triggered the initiation of the Admin Network Interest Module 128 will be selected, for example, if user A set up a bank account 7 days ago and user B set up a bank account 3 days ago and the interest is calculated weekly then user A will be extracted and user B will not be extracted, then the Admin Network Interest Module 128 will be initiated again 4 days later and only user B will be extracted, in an embodiment only users with in-network bank accounts will be extracted, at step 1402. *The Admin Network Interest Module 128 searches for all entries with matching user IDs in the Admin Network Transaction Database 136, transactions may include a user ID, for example, JS1234, bank account number, for example, 543093105088, time and date, for example, 6/19/2020 11:30:00 AM, type of transaction, for example an interest payment, transaction amount, for example, $3.21, whether the transaction is pending, whether the transaction was made using an in-network or out-of-network bank account, or any other metric which is usually collected by bank account companies in regards to bank account deposits, withdrawals, or interest payments, at step 1404. *The Admin Network Interest Module 128 extracts all of the matching entries from the Admin Network Transaction Database 136, transactions may include a user ID, for example, JS1234, bank account number, for example, 543093105088, time and date, for example, 6/19/2020 11:30:00 AM, type of transaction, for example an interest payment, transaction amount, for example, $3.21, whether the transaction is pending, whether the transaction was made using an in-network or out-of-network bank account, or any other metric which is usually collected by bank account companies in regards to bank account deposits, withdrawals, or interest payments, at step 1406. *The Admin Network Interest Module 128 calculates the user's account balance by adding together all the amounts of the user's deposits and interest payments, minus all the withdrawals the user has made, in some embodiments this may not include transactions that are pending, in some embodiments the calculation may be done by subtracting deposits and interest from withdrawals, adding deposits and interest to withdrawals as negative numbers, etc., at step 1408. *The Admin Network Interest Module 128 determines if the user has any money stored in their account on the results of the balance calculation, if not, the Admin Network Interest Module 128 moves on to step 1416, at step 1410. *If the user has any amount of money in their account, The Admin Network Interest Module 128 calculates the interest on that balance by multiplying the account balance by an interest rate, for example, a $100 account balance at a 3% interest rate would be $3 of interest, in some embodiments interest rate may be obtained from a database, other module, or some other external source such as a bank, stock market, or website, at step 1412. *The Admin Network Interest Module 128 stores the interest as a new entry in the Admin Network Transaction Database 136 along with the user ID extracted from the Admin Network User Account Database 134, in some embodiments other data may be extracted in step 1402 to be stored in this step, for example, bank account number, routing number, account type, address, etc., at step 1414. *The Admin Network Interest Module 128 determines if there is another user ID in the Admin Network User Account Database 134, in some embodiments users may be able to sign up for multiple bank accounts, in which case the next user ID may be identical to an already selected user ID, but with a different bank account number, at step 1416. *If there is another user ID in the Admin Network User Account Database 134, The Admin Network Interest Module 128 extracts that user ID and returns to step 1404 at step 1418. *If there are no more user IDs that have not already been extracted, the Admin Network Interest Module 128 stops, in some embodiments the module will return to polling for a specific time interval to begin again, at step 1420.

Functioning of the Admin Network Deposit Module 130 will now be explained with reference to FIG. 15. *The process begins with the Admin Network Deposit Module 130 polling for data from the User Device Banking Portal Module 154, this data includes at least a user ID and an amount to be deposited, in some embodiments deposit information may be another bank account routing number, a debit card, another credit card, a PayPal account, a Zelle account, check or money order information, or any other method of depositing money, at step 1500. *The Admin Network Deposit Module 130 receives data from the User Device Banking Portal Module 154, this data includes at least a user ID and an amount to be deposited, in some embodiments deposit information may be another bank account routing number, a debit card, another credit card, a PayPal account, a Zelle account, check or money order information, or any other method of depositing money, at step 1502. *The Admin Network Deposit Module 130 stores the data received from the User Device Banking Portal Module 154 in the Admin Network Transaction Database 136 as a deposit and sets the status of that deposit to pending, at step 1504. *The Admin Network Deposit Module 130 prompt and administrator to verify the deposit, an administrator may be, for example, an owner of the Admin Network, a person hired to handle deposit approval, or an independent entity that handles bank account deposits, in an embodiment the data is sent to another module which can verify the deposit automatically, the data may be displayed on a GUI as part of the Admin Network or may be sent to an administrator via email, text, fax, etc., at step 1506. *The Admin Network Deposit Module 130 polls for a response from the administrator that the deposit has been verified, in some embodiments if the deposit is not verified a notification is sent to the user, for example “Problem with bank account deposit.”, at step 1508. *The Admin Network Deposit Module 130 changes the pending status of the deposit in the Admin Network Transaction Database 136 pending category from “Y” to “N” indicating that the deposit is no longer pending, at step 1510.

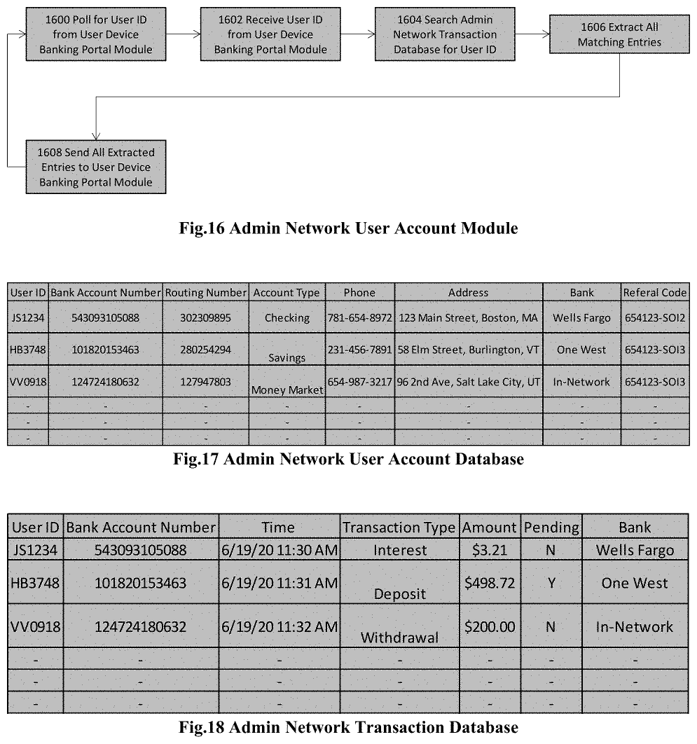

Functioning of the Admin Network User Account Module 132 will now be explained with reference to FIG. 16. *The process begins with the Admin Network User Account Module 132 polling for a user ID from the User Device Banking Portal Module 154, in an embodiment the user may have more than one bank account registered to the same user ID and the Admin Network User Account Module 132 would also poll for a bank account number at step 1600. *The Admin Network User Account Module 132 receives a user ID from the User Device Banking Portal Module 154, for example, JS1234, at step 1602. *The Admin Network User Account Module 132 searches the Admin Network Transaction Database 136 for all entries that match the user ID received from the User Device Banking Portal Module 154 in the user ID category, at step 1604. *The Admin Network User Account Module 132 extracts all entries that match the user ID in the Admin Network Transaction Database 136, for example, if the same user made a deposit, was payed interest, and then made a withdrawal, all three of those transactions would be extracted, transactions may include a user ID, for example, JS1234, bank account number, for example, 543093105088, time and date, for example, 6/19/2020 11:30:00 AM, type of transaction, for example an interest payment, transaction amount, for example, $3.21, whether the transaction is pending, whether the transaction was made using an in-network or out-of-network bank account, or any other metric which is usually collected by bank account companies in regards to bank account deposits, withdrawals, or interest payments, at step 1606. *The Admin Network User Account Module 132 sends the extracted entries to the User Device Banking Portal Module 154 and returns to polling for a user ID, at step 1608.

Functioning of the Admin Network User Account Database 134 will now be explained with reference to FIG. 17. *The database contains information about users who have a bank account including user ID, for example, JS1234, address, for example, 123 Main Street, Boston, Mass., bank account number, for example, 543093105088, bank account routing number, for example, 302309895, account type, for example, checking, code used to sign up, for example, 654123-SOI2, Banking Institution, for example, Wells Fargo, and any other identifying information which may be used as part of a bank account application process or is usually collected by bank account companies, for example, a phone number or other contact, this data is used to identify users via either their user ID or bank account number so that when the user makes a purchase the purchase can be correctly recorded and the upline user, if there is one, can be found using the code used to sign up and paid commission accordingly, for example, the user ID and/or bank account number is used by the Admin Network Interest Module 128 to find all transactions made by that account in the Admin Network Transaction Database 136, and then calculate interest on the outstanding debt.

Functioning of the Admin Network Transaction Database 136 will now be explained with reference to FIG. 18. *The database contains transactions made by users with bank accounts, transactions may include a user ID, for example, JS1234, bank account number, for example, 543093105088, time and date, for example, 6/19/2020 11:30:00 AM, type of transaction, for example an interest payment, transaction amount, for example, $3.21, whether the transaction is pending, whether the transaction was made using an in-network or out-of-network bank account, or any other metric which is usually collected by bank account companies in regards to bank account deposits, withdrawals, or interest payments, this data is used to determine the user's bank account balance which is used by the Admin Network to pay interest and by the user to view their balance and make deposits or withdrawals, for example, these transactions are sent by the Admin Network User Account Module 132 to the User Device Banking Portal Module 154 so that the user can make a deposit or withdrawal, in some embodiments, the user's account may be set up to directly transfer funds to a retailer periodically, for example, a gym membership that is charged monthly, in which case the Admin Network Transaction Database 136 may store additional data on these transfers in order to better keep track of commission trees that are not based on a bank account as the commissionable item.

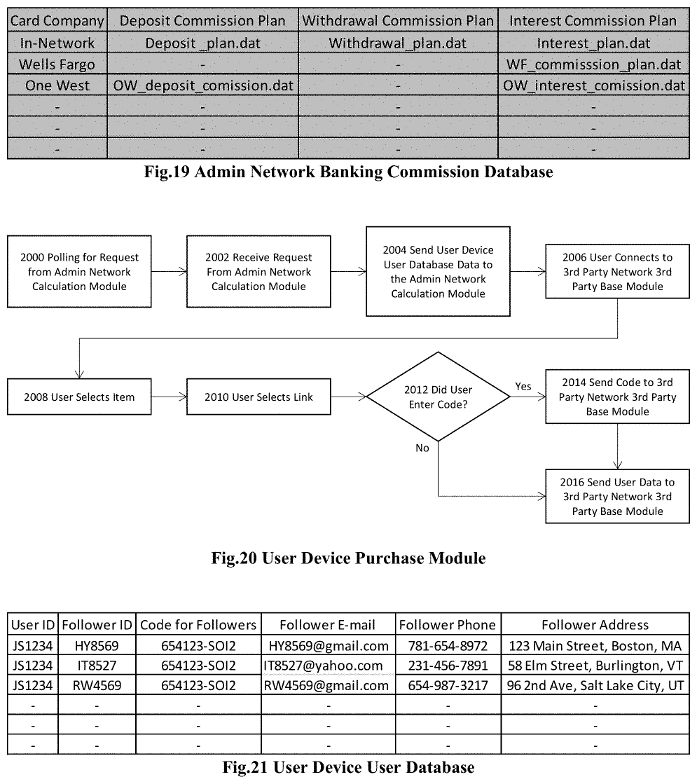

Functioning of the Admin Network Banking Commission Database 138 will now be explained with reference to FIG. 19. *The database contains commission plans for each individual Banking Institution, the plans may treat each type of transaction differently, for example, withdrawals may have a different commission structure than deposits, in some embodiments commission plans may be separated by account type (checking, savings, CD), user ID, sign-up date, etc. In the figure, commission plans are presented as data files as commission plan structures are completely customizable, for example, the file Depositplan.dat may contain the following code:

If (deposit_Amount <= 50)
commission = deposit Amount * 0.02f
else if (deposit_Amount > 50 && deposit_Amount <= 1000)
commission = (deposit_Amount - 50) * 0.01f + 1
else
commission = deposit_Amount * (0.01f / log(deposit_Amount)) + 11

a commission plan data file may hold a simple equation that pays upline users at a decaying rate, or may be much more complex involving different commission structures based on the type of product deposited, for example, gas may pay 3% upline at a 50% decay rate where as food deposits may pay 1% upline at a 40% decay rate, a commission plan data file may hold a simple equation that pays upline users at a decaying rate, or may be much more complex involving different commission structures based on features of the account, for example, an interest on an account with over $50,000 dollars in it may pay 3% upline at a 50% decay rate whereas interest on an account with less than $50,000 in it may pay 1% upline at a 40% decay rate, the commission plan may give upline users different rewards, for example, frequent flier miles, redeemable points, or store credit, a commission plan may be configured to only pay up to a certain amount across all upline users, or may only pay a certain number of upline users, in an embodiment all plans will have to adhere to a rigid structure which includes an initial percentage and a decay rate, this data is used by the Admin Network Banking Commission Module 124 to calculate commissions to be paid to upline users.

Functioning of the User Device Purchase Module 146 will now be explained with reference to FIG. 20. The process begins with the User Device Purchase Module 146 continuously polling for a request from the Admin Network Calculation Module 106 for the User Device User Database 148 data, at step 2000. The User Device Purchase Module 146 receives a request from the Admin Network Calculation Module 106 for the User Device User Database 148 data, at step 2002. Then the User Device Purchase Module 146 sends the User Device User Database 148 data to the Admin Network Calculation Module 106, at step 2004. The User Device Purchase Module 146 connects to the 3rd Party Network 3rd Party Base Module 160, at step 2006. Then the user selects an item from the 3rd Party Network, at step 2008. The user selects the link from the 3rd Party Network, at step 2010. Then the User Device Purchase Module 146 determines if the user entered a code, if not the process continues to sending the data to the 3rd Party Network 3rd Party Base Module 160, at step 2012. If it is determined the user entered a code the User Device Purchase Module 146 sends the code to the 3rd Party Network 3rd Party Base Module 160, at step 2014. The User Device Purchase Module 146 sends the user data to the 3rd Party Network 3rd Party Base Module 160. In some embodiments, the user data may be data to purchase the item such as name, address, billing information, etc. In some embodiments, the user data sent to the 3rd Party Network 3rd Party Base Module 160 may include information from a bank account system. In some embodiments, bank account system may refer to a system that allows cardholders to borrow funds with which to pay for goods and services with the condition that the cardholders pay back the borrowed funds, plus interest, as well as any additional agreed-upon charges, at step 2016.

Functioning of the User Device User Database 148 will now be explained with reference to FIG. 21. This figure displays the User Device User Database 148 which contains the user's followers as well as the follower's information. The User Device User Database 148 contains the user's ID, the followers user's ID, the code provided to the followers, the follower's e-mail address, the follower's phone number, the follower's address. In some embodiments, the User Device User Database 148 may contain the follower's social media information such as Twitter, Instagram, Facebook, etc. In some embodiments, the User Database may contain social media plug-ins for enhanced marketing or social media aggregators. In some embodiments, social media plug ins for enhanced marketing may refer to sharing content with other people through social media platforms, for example a share or like button. In some embodiments, the User Device User Database 148 may contain payment information such as bank accounts, bank account information, PayPal, Venmo, etc. In some embodiments, a user ID or ID Enrollment may refer to a participant enrolling in an MLM product tree through an ID, which is unique to each participant in the MLM system. In some embodiments, social medias aggregators may refer to a tool that allows a person to collate posts and updates from many different social media feeds. It creates an organized view of social posts on a specific topic and are often used to display user-generated content on live social walls.

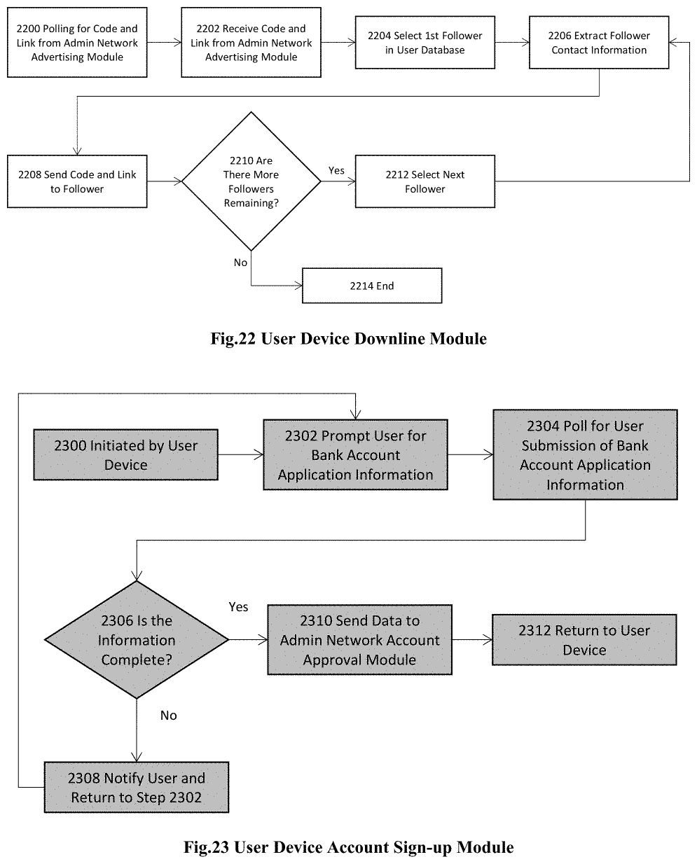

Functioning of the User Device Downline Module 150 will now be explained with reference to FIG. 22. The process begins with the User Device Downline Module 150 continuously polling for the code and the link from the Admin Network Advertising Module 110, at step 2200. The User Device Downline Module 150 receives the code and the link from the Admin Network Advertising Module 110, at step 2202. The User Device Downline Module 150 selects the first follower in the User Device User Database 148, at step 2204. The User Device Downline Module 150 extracts the followers contact information stored in the User Device User Database 148, at step 2206. Then the User Device Downline Module 150 sends the code and link to the follower's contact information. In some embodiments, the code and link may be shared on social media sites, such as Twitter, Instagram, Facebook, etc. for the user's followers to receive the code and link, at step 2208. The User Device Downline Module 150 determines if there are more followers remaining in the User Device User Database 148, at step 2210. If it is determined that there are more followers stored in the User Device User Database 148, the User Device Downline Module 150 selects the next user stored in the User Device User Database 148 and the process returns to step 1206, at step 2212. If the User Device Downline Module 150 determines that there are no more followers remaining in the User Device User Database 148 then the process ends, at step 2214.

Functioning of the User Device Account Sign-up Module 152 will now be explained with reference to FIG. 23. *The process begins with the User Device Account Sign-up Module 152 being initiated by the User Device, in an embodiment this may be done via an interactable button or link on a GUI, for example, a button that says, “Sign-up for a bank account Today!”, at step 2300. *The User Device Account Sign-up Module 152 prompts the user for bank account application information, for example, the user's user ID, address, full name, social security number, and other information which is usually required to apply for a bank account, in an embodiment this may also serve as ID enrollment, such that a user is granted a user ID when they sign-up for a bank account, or the user ID is tied to the bank account number, in some embodiments the only way to have a user ID and therefore participate in the MLM system is applying for an in-network bank account, at step 2302. *The User Device Account Sign-up Module 152 polls for the user submission of the bank account application data, in an embodiment this may be done by having the user click a button on a GUI, for example, a button that says “Submit”, in other embodiments the data may be pulled directly from a database on the User Device, at step 2304. *The User Device Account Sign-up Module 152 determines if the information is complete by checking if all necessary prompts have been filled out, for example, if the user's address is missing then the information is incomplete, in some embodiments the User Device Account Sign-up Module 152 can also determine if a filled out prompt is incomplete, for example, if a zip code is only 4 digits instead of 5 or includes letters instead of only numbers, at step 2306. *If the information is incomplete, the User Device Account Sign-up Module 152 notifies the user that the application is incomplete and returns to step 2302, in some embodiments the User Device CC Sign-up may keep or delete already entered data, in an embodiment the User Device Account Sign-up Module 152 may indicate which prompt is incomplete, at step 2308. *If the information is complete, the User Device Account Sign-up Module 152 sends the submitted data to the Admin Network Account Approval Module 122, at step 2310. *The User Device Account Sign-up Module 152 returns to the User Device, in some embodiments the user may receive a notification that their application has been submitted and is pending approval, at step 2312.

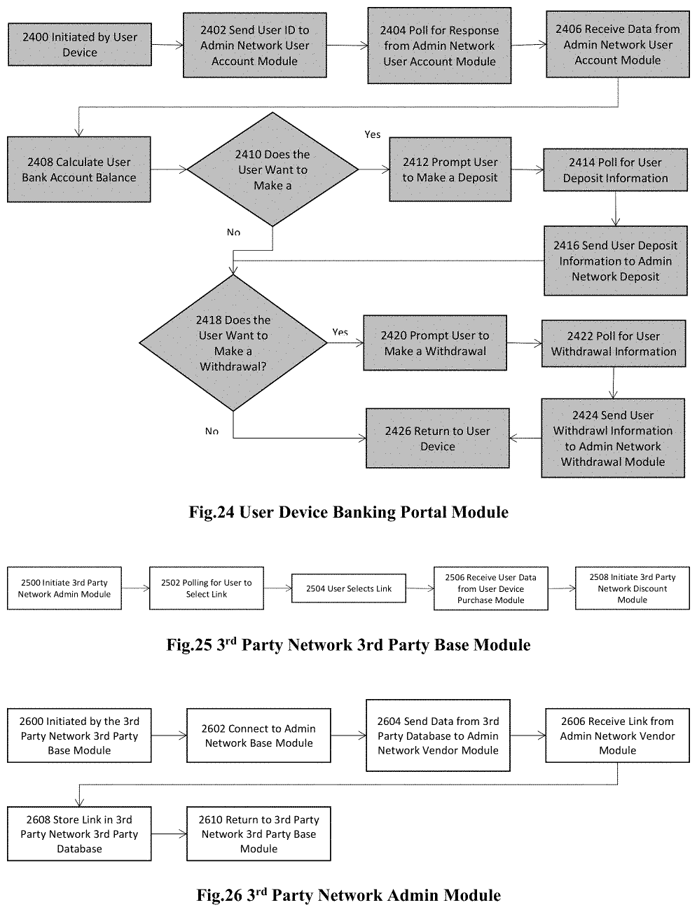

Functioning of the User Device Banking Portal Module 154 will now be explained with reference to FIG. 24. *The process begins with the User Device Banking Portal Module 154 being initiated by the User Device, in an embodiment this may be done via an interactable button or link on a GUI, for example, a button that says, “View Account Balance”, at step 2400. *The User Device Banking Portal Module 154 sends the user's user ID to the Admin Network User Account Module 132, in an embodiment the user ID may be entered by the user to gain access to initiate the module, in another embodiment the user ID may be extracted from another module or a database on the User Device, at step 2402. *The User Device Banking Portal Module 154 polls for a response from the Admin Network User Account Module 132, the response contains transaction data which may include a user ID, for example, JS1234, bank account number, for example, 543093105088, time and date, for example, 6/19/2020 11:30:00 AM, type of transaction, for example an interest payment, transaction amount, for example, $3.21, whether the transaction is pending, whether the transaction was made using an in-network or out-of-network bank account, or any other metric which is usually collected by bank account companies in regards to bank account deposits, withdrawals, or interest payments, in an embodiment the response may also be an error message indicating that the user has no current transactions, at step 2404. *The User Device Banking Portal Module 154 receives user transaction data from the Admin Network User Account Module 132, transaction data which may include a user ID, for example, JS1234, bank account number, for example, 543093105088, time and date, for example, 6/19/2020 11:30:00 AM, type of transaction, for example an interest payment, transaction amount, for example, $3.21, whether the transaction is pending, whether the transaction was made using an in-network or out-of-network bank account, or any other metric which is usually collected by bank account companies in regards to bank account deposits, withdrawals, or interest payments, at step 2406. *The User Device Banking Portal Module 154 calculates the user's bank account balance by adding together all the amounts of the user's deposits and interest fees, minus all the withdrawals the user has made, in some embodiments the calculation may be done by subtracting deposits and interest from withdrawals, adding deposits and interest to withdrawals as negative numbers, etc., in an embodiment, pending transactions are not included, in some embodiments all the separate transactions in the data obtained from the Admin Network User Account Module 132 would be viewable by the user, for example, via a GUI in a formatted table, at step 2408. *The User Device Banking Portal Module 154 determines if the user wants to make a deposit, in an embodiment the User Device Banking Portal Module 154 may include a GUI which has a clickable button or link that allows the user to indicate they want to make a deposit, for example, a link that says, “Make a Deposit”, at step 2410. *If the user wants to make a deposit, the User Device Banking Portal Module 154 prompts the user to make a deposit, the user can then enter the amount they wish to deposit into the account, in some embodiments the user may also enter a source of the deposit such as another bank account, a credit or debit card, a PayPal account, or a Zelle account, in an embodiment user may be prompted for a picture of a check or money order that the user is depositing, in some embodiments the User Device may be an ATM or other machine capable of taking a cash deposit, at step 2412. *The User Device Banking Portal Module 154 polls for the user's deposit information which includes at least an amount to be deposited, in some embodiments deposit information may be, a credit card number, another bank account, a PayPal account, a Zelle account, check or money order information, or any other method of depositing money, at step 2414. *The User Device Banking Portal Module 154 sends the user's deposit information to the Admin Network Deposit Module 130, which includes at least the user's user ID and the amount to be deposited, but may also include another bank account routing number, a debit card, another credit card, a PayPal account, a Zelle account, check or money order information, or any other method of depositing money, at step 2416. *If the user does not want to make a deposit, the Admin Network Banking Portal Module determines if the user wants to make a withdrawal, in an embodiment the User Device Banking Portal Module 154 may include a GUI which has a clickable button or link that allows the user to indicate they want to make a withdrawal, for example, a link that says “Make a Withdrawal”, if the user does not want to make a deposit or withdrawal then the Admin Network Banking Portal Module skips to step 2418, at step 2418. *If the user wants to make a withdrawal, the Admin Network Banking Portal Module prompts the user to make a withdrawal, the user can then enter the amount they wish to withdraw from the account, in some embodiments the user may also specify the form of the withdrawal such as a transfer to another bank account, a payment, a transfer to a PayPal account or a Zelle account, a cash withdrawal, or a check or money order, in some embodiments the User Device may be an ATM or other machine capable of making a cash withdrawal, at step 2420. *The User Device Banking Portal Module 154 polls for the user's withdrawal information which includes at least an amount to be withdrawn, but may also include a bank account routing number, a debit card, a credit card, a PayPal account, a Zelle account, check or money order information, an atm ID, or any other information which may be required to complete the withdrawal, at step 2422. *The User Device Banking Portal Module 154 sends the user's withdrawal information to the Admin Network Withdrawal Module 126, which includes at least a user ID and an amount to be withdrawn, but may also include a bank account routing number, a debit card, a credit card, a PayPal account, a Zelle account, check or money order information, an atm ID, or any other information which may be required to complete the withdrawal, at step 2424. *The User Device Banking Portal Module 154 returns to the User Device, in some embodiment the user may continue to view their transactions after the module has returned to the User Device, at step 2426.

Functioning of the 3rd Party Network 3rd Party Base Module 160 will now be explained with reference to FIG. 25. The process begins with the 3rd Party Network 3rd Party Base Module 160 initiating the 3rd Party Network Admin Module 162, at step 2500. Then the 3rd Party Network 3rd Party Base Module 160 continuously polls for the user to select the link, at step 2502. The user selects the link on the 3rd Party Network, at step 2504. Then the 3rd Party Network 3rd Party Base Module 160 receives the user data from the User Device Purchase Module 146. In some embodiments, the user data may be data to purchase the item such as name, address, billing information, etc., at step 2506. Then the 3rd Party Network 3rd Party Base Module 160 initiates the 3rd Party Network Discount Module 164, at step 2508.

Functioning of the 3rd Party Network Admin Module 162 will now be explained with reference to FIG. 26. The process begins with the 3rd Party Network Admin Module 162 being initiated by the 3rd Party Network 3rd Party Base Module 160, at step 2600. The 3rd Party Network Admin Module 162 connects to the Admin Network Base Module 104, at step 2602. Then the 3rd Party Network Admin Module 162 sends the 3rd Party Network 3rd Party Database 166 to the Admin Network Vendor Module 114, at step 2604. The 3rd Party Network Admin Module 162 receives the link for the item from the Admin Network Vendor Module 114, at step 2606. Then the 3rd Party Network Admin Module 162 stores the link in the 3rd Party Network 3rd Party Database 166, at step 2608. Then the 3rd Party Network Admin Module 162 returns to the 3rd Party Network 3rd Party Base Module 160, at step 2610.

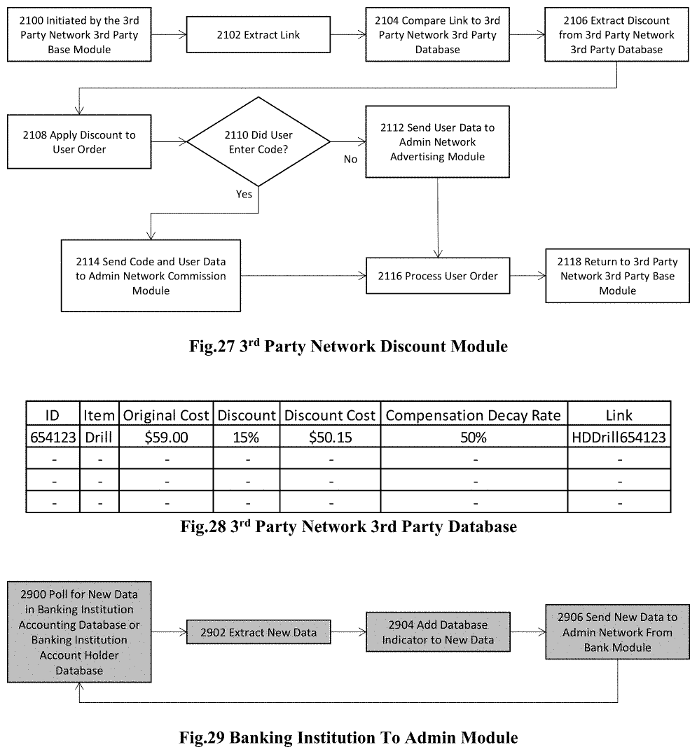

Functioning of the 3rd Party Network Discount Module 164 will now be explained with reference to FIG. 27. The process begins with the 3rd Party Network 3rd Party Base Module 160 initiating the 3rd Party Network Discount Module 164, at step 2700. The 3rd Party Network Discount Module 164 extracts the link received from the user through the process described in the 3rd Party Network 3rd Party Base Module 160, at step 2702. Then the 3rd Party Network Discount Module 164 compares the extracted link to the 3rd Party Network 3rd Party Database 166, at step 2704. The 3rd Party Network Discount Module 164 extracts the corresponding discount using the extracted link from the 3rd Party Network 3rd Party Database 166, at step 2706. Then the 3rd Party Network Discount Module 164 applies the extracted discount to the user's order, at step 2708. The 3rd Party Network Discount Module 164 determines if the user entered a code, at step 2710. If it is determined that the user did not enter a code the 3rd Party Network Discount Module 164 sends the user data to the Admin Network Advertising Module 110, at step 2712. If it is determined that the user entered a code the 3rd Party Network Discount Module 164 sends the code and the user data to the Admin Network Commission Module 108, at step 2714. The 3rd Party Network Discount Module 164 processes the user's order, at step 2716. Then the 3rd Party Network Discount Module 164 returns to the 3rd Party Network 3rd Party Base Module 160, at step 2718.

Functioning of the 3rd Party Network 3rd Party Database 166 will now be explained with reference to FIG. 28. This figure displays the 3rd Party Network 3rd Party Database 166 which contains the information about the items enrolled in the MLM system as well as the link created by the Admin Network Vendor Module 114. The 3rd Party Network 3rd Party Database 166 contains the item ID, the item, the original cost of the item, the discount provided by the 3rd Party for the item, the cost of the item with the discount, the compensation plan decay rate which the 3rd party enters, and the link received from the Admin Network Vendor Module 114. In some embodiments, the 3rd Party Network 3rd Party Database 166 may include the rates of exchange for product returns, marketing materials, airline sky miles, etc. In some embodiments, product returns may refer to a process in which a customer or consumer takes previously purchased product, merchandise, or goods back to the retailer, and in turn receive a refund in the original form of payment, exchange for another item (identical or different), or a store credit. In some embodiments, the information about the product or service may be advertisements to the network, or as seen on TV sales. Advertisements to the network may refer to the advertisement provided to the MLM system from the 3rd party offering a product, good or service. In some embodiments, as seen on TV sales may refer to a generic nameplate for products advertised on television in the United States for direct response mail-order through a toll-free telephone number. In some embodiments, marketing materials may refer to a means of marketing, advertising or promotional materials developed by or for license (or subject to licensee's approval) that promote the sale of the licensed product, including but not limited to, television, radio and online advertising, point of sale materials (e.g. posters, counter-cards), packaging advertising, print media and all audio or video media. In some embodiments, airline sky miles may refer to a loyalty program offered by airlines and/or bank accounts. Typically, consumers accumulate a set amount of miles based on how much is spent on a ticket or a bank account and are also known as frequent flyer miles or travel points.

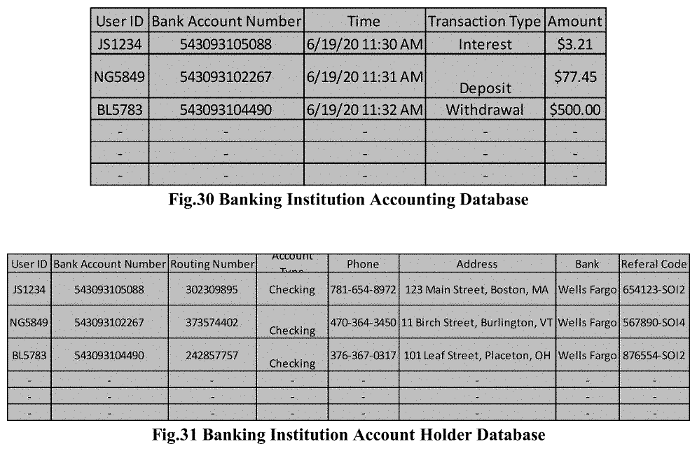

Functioning of the Banking Institution To Admin Module 172 will now be explained with reference to FIG. 29. *The process begins with the Banking Institution To Admin Module 172 polling for new data in either the Banking Institution Accounting Database 174 or the Banking Institution Account Holder Database 176, data from the Banking Institution Accounting Database 174 may include a user ID, for example, JS1234, bank account number, for example, 543093105088, time and date, for example, 6/19/2020 11:30:00 AM, type of transaction, for example an interest payment, transaction amount, data from the Banking Institution Account Holder Database 176 may include a user ID, for example, JS1234, address, for example, 123 Main Street, Boston, Mass., bank account number, for example, 543093105088, bank account routing number, for example, 302309895, account type, for example, checking, code used to sign up, for example, 654123-SOI2, Banking Institution, for example, Wells Fargo, and any other identifying information which may be used as part of a bank account application process or is usually collected by bank account companies, for example, a phone number or other contact, at step 2900. *The Banking Institution To Admin Module 172 extracts the new data from either the Banking Institution Accounting Database 174 or the Banking Institution Account Holder Database 176, data from the Banking Institution Accounting Database 174 may include a user ID, for example, JS1234, bank account number, for example, 543093105088, time and date, for example, 6/19/2020 11:30:00 AM, type of transaction, for example an interest payment, transaction amount, data from the Banking Institution Account Holder Database 176 may include a user ID, for example, JS1234, address, for example, 123 Main Street, Boston, Mass., bank account number, for example, 543093105088, bank account routing number, for example, 302309895, account type, for example, checking, code used to sign up, for example, 654123-SOI2, Banking Institution, for example, Wells Fargo, and any other identifying information which may be used as part of a bank account application process or is usually collected by bank account companies, for example, a phone number or other contact, at step 2902. *The Banking Institution To Admin Module 172 adds an indicator to the data that indicates which database it originated from, in some embodiments this may be a Boolean, integer, or string that the Admin Network From Bank Module 120 will recognize or can compare to a database, for example, the string “Accounting Database” may indicate the data originates from the Banking Institution Accounting Database 174, at step 2904. *The Banking Institution To Admin Module 172 sends the extracted data with the database indicator to the Admin Network From Bank Module 120, data from the Banking Institution Accounting Database 174 may include a user ID, for example, JS1234, bank account number, for example, 543093105088, time and date, for example, 6/19/2020 11:30:00 AM, type of transaction, for example an interest payment, transaction amount, data from the Banking Institution Account Holder Database 176 may include a user ID, for example, JS1234, address, for example, 123 Main Street, Boston, Mass., bank account number, for example, 543093105088, bank account routing number, for example, 302309895, account type, for example, checking, code used to sign up, for example, 654123-SOI2, Banking Institution, for example, Wells Fargo, and any other identifying information which may be used as part of a bank account application process or is usually collected by bank account companies, for example, a phone number or other contact, in some embodiments the Banking Institution To Admin Module 172 may take several additional steps before or after sending the data to the Admin Network to ensure data security, for example, provision of encryption and tamper detection algorithms, transactions with a Blockchain system platform in a storage facility to secure such data against tampering, checks on all processed transactions, as well as to verify that records have not been altered, falsified, etc., at step 2906.

Functioning of the Banking Institution Accounting Database 174 will now be explained with reference to FIG. 30. *The database contains transactions made by users who obtained a bank account from the Banking Institution using a referral code from the Admin Network Code Database 118, transactions may include a user ID, for example, JS1234, bank account number, for example, 543093105088, time and date, for example, 6/19/2020 11:30:00 AM, type of transaction, for example an interest payment, transaction amount, for example, $3.21, this data may be used by the Banking Institution for their own purposes but will also be sent to the Admin Network via the Banking Institution To Admin Module 172 so that upline users can be compensated for the transactions made by downline users.

Functioning of the Banking Institution Account Holder Database 176 will now be explained with reference to FIG. 31. *The database contains the bank account information and personal information of users who obtained a bank account from the Banking Institution using a referral code from the Admin Network Code Database 118 and may include a user ID, for example, JS1234, address, for example, 123 Main Street, Boston, Mass., bank account number, for example, 543093105088, bank account routing number, for example, 302309895, account type, for example, checking, code used to sign up, for example, 654123-SOI2, Banking Institution, for example, Wells Fargo, and any other identifying information which may be used as part of a bank account application process or is usually collected by bank account companies, for example, a phone number or other contact, this data is used to identify users via either their user ID or bank account number so that when the user makes a purchase the purchase can be correctly recorded and the upline user, if there is one, can be found using the code used to sign up and paid commission accordingly, in some embodiments this database may contain more information than is needed by the admin network in which case the Banking Institution To Admin Module 172 or another module will filter out the unneeded information, this data may be used by the Banking Institution for their own purposes but will also be sent to the Admin Network via the Banking Institution To Admin Module 172 so that upline users can be compensated for the transactions made by downline users.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

1. (canceled)

2. A method of tracking networked users of online services, the method comprising:
storing information in memory regarding a plurality of different users each associated with a corresponding code;
tracking online activity by a user device, wherein the online activity is associated with a new account with one of a plurality of different network systems;
identifying that the online activity associated with the new account includes use of a link that includes a received code;
storing information regarding a user of the user device based on a determination that the received code corresponds to a stored code in memory;
assigning a sphere of influence level to the user based on a set of one or more users associated with the stored code in memory; and
applying one or more dynamic incentives to the new account of the user based on the online activity, wherein one or more different dynamic incentives are applied to one or more accounts of the set of users based on the assigned sphere of influence.

3. The method of claim 2, wherein the online activity includes automatic application of the received code to a webpage associated with the link.

4. The method of claim 2, wherein the new account is a financial account, and wherein the network system associated with the new account provides one or more online banking services.

5. The method of claim 2, wherein the set of one or more users associated with the stored code in memory correspond to upline users within the sphere of influence, and further comprising generating a new code associated with the user, wherein a subsequent set of one or more user that use of the link with the new code correspond to downline users within the sphere of influence.

6. The method of claim 5, wherein the different dynamic incentives are based on the respective sphere of influence level of each user in the set.

7. The method of claim 2, further comprising applying a decay rate to the dynamic incentives based on the assigned sphere of influence.

8. The method of claim 2, further comprising continuously updating the dynamic incentives.

9. The method of claim 2, further comprising tracking further online activity associated with the new account, and applying one or more dynamic rewards to the new account based on the further online activity.

10. A non-transitory, computer-readable storage medium, having embodied thereon a program executable by a processor to perform a method of tracking networked users of online services, the method comprising:
storing information in memory regarding a plurality of different users each associated with a corresponding code;
tracking online activity by a user device, wherein the online activity is associated with a new account with one of a plurality of different network systems;
identifying that the online activity associated with the new account includes use of a link that includes a received code;
storing information regarding a user of the user device based on a determination that the received code corresponds to a stored code in memory;
assigning a sphere of influence level to the user based on a set of one or more users associated with the stored code in memory; and
applying one or more dynamic incentives to the new account of the user based on the online activity, wherein one or more different dynamic incentives are applied to one or more accounts of the set of users based on the assigned sphere of influence.

11. The non-transitory, computer-readable storage medium of claim 10, wherein the online activity includes automatic application of the received code to a webpage associated with the link.

12. The non-transitory, computer-readable storage medium of claim 10, wherein the new account is a financial account, and wherein the network system associated with the new account provides one or more online banking services.

13. The non-transitory, computer-readable storage medium of claim 10, wherein the set of one or more users associated with the stored code in memory correspond to upline users within the sphere of influence, and further comprising generating a new code associated with the user, wherein a subsequent set of one or more user that use of the link with the new code correspond to downline users within the sphere of influence.

14. The non-transitory, computer-readable storage medium of claim 13, wherein the different dynamic incentives are based on the respective sphere of influence level of each user in the set.

15. The non-transitory, computer-readable storage medium of claim 10, further comprising applying a decay rate to the dynamic incentives based on the assigned sphere of influence.

16. The non-transitory, computer-readable storage medium of claim 10, further comprising continuously updating the dynamic incentives.

17. The non-transitory, computer-readable storage medium of claim 10, further comprising tracking further online activity associated with the new account, and applying one or more dynamic rewards to the new account based on the further online activity.

18. A system of tracking networked users of online services, the system comprising:
a communication interface that communicates over a communication network, wherein the communication interface receives information regarding online activity by a user device, wherein the online activity includes use of a received code in association with a new account with one of a plurality of different network systems;
memory that:
stores information regarding a plurality of different users each associated with a corresponding code; and
stores information regarding a user of the user device based on a determination that the received code corresponds to a stored code in memory;
a processor that executes instructions stored in memory, wherein the processor executes the instructions to:
identify that the online activity associated with the new account includes use of a link that includes the received code;
assign a sphere of influence level to the user based on a set of one or more users associated with the stored code in memory; and
apply one or more dynamic incentives to the new account of the user based on the online activity, wherein one or more different dynamic incentives are applied to one or more accounts of the set of users based on the assigned sphere of influence.
